(19) United States
(12) Patent Application Publication
(10) Pub. No.: US 2026/0292584 A1
(43) Pub. Date: Sep. 24, 2026

(54) APPARATUS, METHOD, AND COMPUTER PROGRAM

(71) Applicant: Nokia Technologies Oy, Espoo (FI)

(72) Inventors: Colin KAHN, Murray Hill, NJ (US); Devaki CHANDRAMOULI, Dallas, TX (US); Markus Sakari ISOMÄKI, Espoo (FI)

(21) Appl. No.: 19/472,421

(22) PCT Filed: Apr. 4, 2024
(86) PCT No.: PCT/EP2024/059122

§ 371 Date: Oct. 3, 2025

Related U.S. Application Data
(60) Provisional application No. 63/494,966, filed on Apr. 7, 2023.

(51) Int. Cl. H04W 28/02; H04W 28/06

(52) U.S. Cl. CPC H04W 28/0268; H04W 28/0284; H04W 28/06

(57) ABSTRACT

There is provided an apparatus, method, and computer program for performing detecting congestion in an access network; identifying, for a quality of service flow, a rate and/or probability at which at least one protocol data unit set is to be discarded based on an indication of a respective quality of service flow priority value and a respective protocol data unit set importance value that identifies a priority of the at least one protocol data unit set within the quality of service flow; and discarding the at least one protocol data unit set in accordance with the identified rate and/or probability.

### TECHNICAL FIELD

The examples described herein generally relate to apparatus, methods, and computer programs, and more particularly (but not exclusively) to apparatus, methods and computer programs for apparatus.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined therein. Examples include the so-called 5G standards.

### SUMMARY

According to a first example, there is provided an apparatus comprising: at least one processor; and at least one memory storing instructions that, when executed by the at least one processor, cause the apparatus at least to perform: detecting congestion in an access network; identifying, for a quality of service flow, a rate and/or probability at which at least one protocol data unit set is to be discarded, based on (e.g., using) an indication of a respective quality of service flow priority value and a respective protocol data unit set importance value that identifies a priority of the at least one protocol data unit set within the quality of service flow; and discarding the at least one protocol data unit set in accordance with the identified rate and/or probability.

A higher quality of service flow priority value may be associated with a higher rate and/or probability of discard when congestion is detected in the access network.

The protocol data unit set importance value may be received in a header from a user plane function.

The quality of service flow priority value may be received in a quality of service profile from a session management function.

The at least one memory stores the instructions that, when executed by the at least one processor, may further cause the apparatus at least to perform: receiving, the respective quality of service flow priority value; and/or receiving, the respective protocol data unit set importance value.

The at least one memory stores the instructions that, when executed by the at least one processor, may further cause the apparatus at least to perform: functionality performed by a user equipment.

The apparatus may be implemented by the user equipment.

The at least one memory stores the instructions that, when executed by the at least one processor, may further cause the apparatus at least to perform: functionality performed by an access network node.

The apparatus may be implemented by the access network node.

The at least one memory stores the instructions that, when executed by the at least one processor, may further cause the apparatus at least to perform: receiving, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify a rate and/or probability at which the at least one protocol data unit set is to be discarded in the multiple quality of service flows; and using the correlation identifier to further identify said rate and/or probability at which the at least one protocol data unit set is to be discarded in the multiple quality of service flows.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The at least one memory stores the instructions that, when executed by the at least one processor, may further cause the apparatus at least to perform: receiving an offset associated with one or more Quality of Service Flows; and using the offset to modify the protocol data unit set importance value to create a modified protocol data unit set importance value that is used in identifying the rate and/or probability.

The Quality of Service Flows may be at least one of: Quality of Service flows for which a Quality of Service offset is received; and/or Quality of Service flows for which an offset is received and also have the same correlation identifier.

According to a second example, there is provided an apparatus comprising:
at least one processor; and at least one memory comprising instructions that, when executed by the at least one processor, cause the apparatus to perform: detecting congestion in an access network; identifying a rate and/or probability at which at least one protocol data unit set is to be discarded based on (e.g., using) a respective protocol data unit set importance value that identifies a priority of the at least one protocol data unit set within a quality of service flow, a correlation identifier that associates multiple quality of service flows, and an indication that the protocol data unit set importance value for the at least one protocol data unit set is to be used with the correlation identifier to identify the rate and/or probability at which the at least one protocol data unit set is to be discarded across multiple quality of service flows; and discarding the at least one protocol data unit set in the multiple quality of service flows in accordance with the identified rate and/or probability.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The at least one memory stores the instructions that, when executed by the at least one processor, may further cause the apparatus at least to perform: receiving an offset associated with one or more Quality of Service Flows; and using the offset to modify a protocol data unit set importance value to create a modified protocol data unit set importance value, wherein the modified protocol data unit set importance value is used in identifying the rate and/or probability at which the at least one protocol data unit set is to be discarded in the multiple quality of service flows

The at least one memory stores the instructions that, when executed by the at least one processor, may further cause the apparatus at least to perform: receiving the respective protocol data unit set importance value; receiving the correlation identifier; and/or receiving the indication that the protocol data unit set importance value for the at least one protocol data unit set is to be used with the correlation identifier to identify a rate and/or probability at which the at least one protocol data unit set is to be discarded across multiple quality of service flows.

The at least one memory stores the instructions that, when executed by the at least one processor, may further cause the apparatus at least to perform: receiving a quality of service profile, the quality of service profile comprising or being associated with at least one of: the correlation identifier, and/or the indication that the protocol data unit set importance value for the at least one protocol data unit set is to be used with the correlation identifier to identify a rate and/or probability at which the at least one protocol data unit set is to be discarded across multiple quality of service flows.

The at least one memory stores the instructions that, when executed by the at least one processor, may further cause the apparatus at least to perform: receiving, for at least one quality of service flow, an indication of a respective quality of service flow priority value; and using the respective quality of service flow priority value to further identify said rate and/or probability.

The at least one memory stores the instructions that, when executed by the at least one processor, may further cause the apparatus at least to perform: functionality performed by an access network node.

The apparatus may be implemented by the access network node.

According to a third example, there is provided an apparatus comprising: at least one processor; and at least one memory comprising instructions that, when executed by the at least one processor, cause the apparatus to perform: signalling, to a policy control function, a request for quality of service for an application flow for which protocol data unit set based handling may apply, the request comprising a service identifier that indicates a plurality of media flows grouped together, and a coordination indication indicating that the grouping is for determining packet discard in the event of congestion has been detected in an access network and that a protocol data unit set importance value that identifies a priority of at least one protocol data unit set within a quality of service flow is to be used to identify a rate and/or probability at which the at least one protocol data unit set is to be discarded.

The at least one memory stores the instructions that, when executed by the at least one processor, may further cause the apparatus at least to perform: signalling, to the policy control function, an offset value to be used in modifying the protocol data unit set importance value.

The at least one memory stores the instructions that, when executed by the at least one processor, may further cause the apparatus at least to perform: functionality performed by at least one of: an application function or an application server.

The at least one memory stores the instructions that, when executed by the at least one processor, may further cause the apparatus at least to perform: implementing a virtual network function instance of at least one of: an application function or an application server.

According to a fourth example, there is provided an apparatus comprising: at least one processor; and at least one memory comprising instructions that, when executed by the at least one processor, cause the apparatus at least to perform: receiving, from an application function, a request for quality of service for an application flow for which protocol data unit set based handling may be applied, the request comprising: a service identifier that indicates a plurality of media flows grouped together for the purpose of packet discard in the event of congestion has been detected in an access network; and a coordination indication indicating that a protocol data unit set importance value that identifies a priority of at least one protocol data unit set within a quality of service flow is to be used to identify a rate and/or probability at which the at least one protocol data unit set is to be discarded; generating at least one policy rule, the at least one policy rule comprising or being associated with a correlation identifier, and the coordination indication received; and providing the at least one policy rule to a session management function.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The at least one memory stores the instructions that, when executed by the at least one processor, may further cause the apparatus at least to perform: receiving an offset value to be used in modifying the protocol data unit set importance value, wherein said generating further comprises comprising the offset value in the at least one policy rule.

The generating may be performed based on (e.g., using) at least one of: the service identifier, an application identifier, network slice, application identifier and/or a protocol description.

The at least one memory stores the instructions that, when executed by the at least one processor, may further cause the apparatus at least to perform: generating the correlation identifier for associating a plurality of said at least one policy rules.

The at least one memory stores the instructions that, when executed by the at least one processor, may further cause the apparatus at least to perform: functionality performed by a policy control function.

The at least one memory stores the instructions that, when executed by the at least one processor, may further cause the apparatus at least to perform: implementing a virtual network function instance of a policy control function.

According to a fifth example, there is provided an apparatus comprising: at least one processor; and at least one memory comprising instructions that, when executed by the at least one processor, cause the apparatus at least to perform: receiving, from a policy control function, at least one policy rule, the at least one policy rule comprising or being associated with: a correlation identifier that indicates a plurality of media flows grouped together for the purpose of packet discard in the event of congestion has been detected in an access network; and a coordination indication that indicates that a protocol data unit set importance value that identifies a priority of at least one protocol data unit set within a quality of service flow is to be used to identify a rate and/or probability at which the at least one protocol data unit set is to be discarded; and providing the correlation identifier and the coordination indication to an access network node.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The at least one memory stores the instructions that, when executed by the at least one processor, may further cause the apparatus at least to perform: determining at least one quality of service profile that associates at least one service data flow to a respective quality of service flow, said quality of service profile comprising the correlation identifier and the coordination identifier; and providing the at least one quality of service profile to an access network node.

The at least one memory stores the instructions that, when executed by the at least one processor, may further cause the apparatus at least to perform: receiving, from the policy control function an offset value to be used in modifying the protocol data unit set importance value, wherein said determining the at least one quality of service profile comprises comprising the offset value in the at least one quality of service profile.

The at least one memory stores the instructions that, when executed by the at least one processor, may further cause the apparatus at least to perform: functionality performed by a session management function.

The at least one memory stores the instructions that, when executed by the at least one processor, may further cause the apparatus at least to perform: implementing a virtual network function instance of the session management function.

According to a sixth example, there is provided an apparatus comprising means for performing: detecting congestion in an access network; identifying, for a quality of service flow, a rate and/or probability at which at least one protocol data unit set is to be discarded based on (e.g., using) an indication of a respective quality of service flow priority value and a respective protocol data unit set importance value that identifies a priority of the at least one protocol data unit set within the quality of service flow; and discarding the at least one protocol data unit set in accordance with the identified rate and/or probability.

A higher quality of service flow priority value may be associated with a higher rate and/or probability of discard when congestion is detected in the access network.

The protocol data unit set importance value may be received in a header from a user plane function.

The quality of service flow priority value may be received in a quality of service profile from a session management function.

The apparatus may comprise means for performing: receiving, the respective quality of service flow priority value; and/or receiving, the respective protocol data unit set importance value.

The apparatus may comprise means for performing: functionality performed by a user equipment.

The apparatus may be implemented by the user equipment.

The apparatus may comprise means for performing: functionality performed by an access network node.

The apparatus may be implemented by the access network node.

The apparatus may comprise means for performing: receiving, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify a rate and/or probability at which the at least one protocol data unit set is to be discarded in the multiple quality of service flows; and using the correlation identifier to further identify said rate and/or probability at which the at least one protocol data unit set is to be discarded in the multiple quality of service flows.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise means for performing: receiving an offset associated with one or more Quality of Service Flows; and using the offset to modify the protocol data unit set importance value to create a modified protocol data unit set importance value that is used in identifying the rate and/or probability.

The Quality of Service Flows may be at least one of: Quality of Service flows for which a Quality of Service offset is received; and/or Quality of Service flows for which an offset is received and also have the same correlation identifier.

According to a seventh example, there is provided an apparatus comprising means for performing: detecting congestion in an access network; identifying a rate and/or probability at which at least one protocol data unit set is to be discarded based on (e.g., using) a respective protocol data unit set importance value that identifies a priority of the at least one protocol data unit set within a quality of service flow, a correlation identifier that associates multiple quality of service flows, and an indication that the protocol data unit set importance value for the at least one protocol data unit set is to be used with the correlation identifier to identify the rate and/or probability at which the at least one protocol data unit set is to be discarded across multiple quality of service flows; and discarding the at least one protocol data unit set in the multiple quality of service flows in accordance with the identified rate and/or probability.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise means for performing: receiving an offset associated with one or more Quality of Service Flows; and using the offset to modify a protocol data unit set importance value to create a modified protocol data unit set importance value, wherein the modified protocol data unit set importance value is used in identifying the rate and/or probability at which the at least one protocol data unit set is to be discarded in the multiple quality of service flows

The apparatus may comprise means for performing: receiving the respective protocol data unit set importance value; receiving the correlation identifier; and/or receiving the indication that the protocol data unit set importance value for the at least one protocol data unit set is to be used with the correlation identifier to identify a rate and/or probability at which the at least one protocol data unit set is to be discarded across multiple quality of service flows.

The apparatus may comprise means for performing: receiving a quality of service profile, the quality of service profile comprising or being associated with at least one of: the correlation identifier, and/or the indication that the protocol data unit set importance value for the at least one protocol data unit set is to be used with the correlation identifier to identify a rate and/or probability at which the at least one protocol data unit set is to be discarded across multiple quality of service flows.

The apparatus may comprise means for performing: receiving, for at least one quality of service flow, an indication of a respective quality of service flow priority value; and using the respective quality of service flow priority value to further identify said rate and/or probability.

The apparatus may comprise means for performing: functionality performed by an access network node.

The apparatus may be implemented by the access network node.

According to an eighth example, there is provided an apparatus comprising means for performing: signalling, to a policy control function, a request for quality of service for an application flow for which protocol data unit set based handling may apply, the request comprising a service identifier that indicates a plurality of media flows grouped together, and a coordination indication indicating that the grouping is for determining packet discard in the event of congestion has been detected in an access network and that a protocol data unit set importance value that identifies a priority of at least one protocol data unit set within a quality of service flow is to be used to identify a rate and/or probability at which the at least one protocol data unit set is to be discarded.

The apparatus may comprise means for performing: signalling, to the policy control function, an offset value to be used in modifying the protocol data unit set importance value.

The apparatus may comprise means for performing: functionality performed by at least one of: an application function or an application server.

The apparatus may comprise means for performing: implementing a virtual network function instance of at least one of: an application function or an application server.

According to a ninth example, there is provided an apparatus comprising means for performing: receiving, from an application function, a request for quality of service for an application flow for which protocol data unit set based handling may be applied, the request comprising: a service identifier that indicates a plurality of media flows grouped together for the purpose of packet discard in the event of congestion has been detected in an access network; and a coordination indication indicating that a protocol data unit set importance value that identifies a priority of at least one protocol data unit set within a quality of service flow is to be used to identify a rate and/or probability at which the at least one protocol data unit set is to be discarded; generating at least one policy rule, the at least one policy rule comprising or being associated with a correlation identifier, and the coordination indication received; and providing the at least one policy rule to a session management function.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise means for performing: receiving an offset value to be used in modifying the protocol data unit set importance value, wherein said generating further comprises comprising the offset value in the at least one policy rule. The generating may be performed based on (e.g., using) at least one of: the service identifier, an application identifier, network slice, application identifier and/or a protocol description.

The apparatus may comprise means for performing: generating the correlation identifier for associating a plurality of said at least one policy rules.

The apparatus may comprise means for performing: functionality performed by a policy control function.

The apparatus may comprise means for performing: implementing a virtual network function instance of a policy control function.

According to a tenth example, there is provided an apparatus comprising means for performing: receiving, from a policy control function, at least one policy rule, the at least one policy rule comprising or being associated with: a correlation identifier that indicates a plurality of media flows grouped together for the purpose of packet discard in the event of congestion has been detected in an access network; and a coordination indication that indicates that a protocol data unit set importance value that identifies a priority of at least one protocol data unit set within a quality of service flow is to be used to identify a rate and/or probability at which the at least one protocol data unit set is to be discarded; and providing the correlation identifier and the coordination indication to an access network node.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise means for performing: determining at least one quality of service profile that associates at least one service data flow to a respective quality of service flow, said quality of service profile comprising the correlation identifier and the coordination identifier; and providing the at least one quality of service profile to an access network node.

The apparatus may comprise means for performing: receiving, from the policy control function an offset value to be used in modifying the protocol data unit set importance value, wherein said determining the at least one quality of service profile comprises comprising the offset value in the at least one quality of service profile.

The apparatus may comprise means for performing: functionality performed by a session management function.

The apparatus may comprise means for performing: implementing a virtual network function instance of the session management function.

According to an eleventh example, there is provided a method for an apparatus, the method comprising: detecting congestion in an access network; identifying, for a quality of service flow, a rate and/or probability at which at least one protocol data unit set is to be discarded based on (e.g., using) an indication of a respective quality of service flow priority value and a respective protocol data unit set importance value that identifies a priority of the at least one protocol data unit set within the quality of service flow; and discarding the at least one protocol data unit set in accordance with the identified rate and/or probability.

A higher quality of service flow priority value may be associated with a higher rate and/or probability of discard when congestion is detected in the access network.

The protocol data unit set importance value may be received in a header from a user plane function.

The quality of service flow priority value may be received in a quality of service profile from a session management function.

The method may comprise: receiving, the respective quality of service flow priority value; and/or receiving, the respective protocol data unit set importance value.

The method may comprise: performing functionality performed by a user equipment.

The apparatus may be implemented by the user equipment.

The method may comprise performing: functionality performed by an access network node.

The apparatus may be implemented by the access network node.

The method may comprise: receiving, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify a rate and/or probability at which the at least one protocol data unit set is to be discarded in the multiple quality of service flows; and using the correlation identifier to further identify said rate and/or probability at which the at least one protocol data unit set is to be discarded in the multiple quality of service flows.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The method may comprise: receiving an offset associated with one or more Quality

of Service Flows; and using the offset to modify the protocol data unit set importance value to create a modified protocol data unit set importance value that is used in identifying the rate and/or probability.

The Quality of Service Flows may be at least one of: Quality of Service flows for which a Quality of Service offset is received; and/or Quality of Service flows for which an offset is received and also have the same correlation identifier.

According to a twelfth example, there is provided a method for an apparatus, the method comprising: detecting congestion in an access network; identifying a rate and/or probability at which at least one protocol data unit set is to be discarded based on (e.g., using) a respective protocol data unit set importance value that identifies a priority of the at least one protocol data unit set within a quality of service flow, a correlation identifier that associates multiple quality of service flows, and an indication that the protocol data unit set importance value for the at least one protocol data unit set is to be used with the correlation identifier to identify the rate and/or probability at which the at least one protocol data unit set is to be discarded across multiple quality of service flows; and discarding the at least one protocol data unit set in the multiple quality of service flows in accordance with the identified rate and/or probability.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The method may comprise: receiving an offset associated with one or more Quality of Service Flows; and using the offset to modify a protocol data unit set importance value to create a modified protocol data unit set importance value, wherein the modified protocol data unit set importance value is used in identifying the rate and/or probability at which the at least one protocol data unit set is to be discarded in the multiple quality of service flows

The method may comprise: receiving the respective protocol data unit set importance value; receiving the correlation identifier; and/or receiving the indication that the protocol data unit set importance value for the at least one protocol data unit set is to be used with the correlation identifier to identify a rate and/or probability at which the at least one protocol data unit set is to be discarded across multiple quality of service flows.

The method may comprise: receiving a quality of service profile, the quality of service profile comprising or being associated with at least one of: the correlation identifier, and/or the indication that the protocol data unit set importance value for the at least one protocol data unit set is to be used with the correlation identifier to identify a rate and/or probability at which the at least one protocol data unit set is to be discarded across multiple quality of service flows.

The method may comprise: receiving, for at least one quality of service flow, an indication of a respective quality of service flow priority value; and using the respective quality of service flow priority value to further identify said rate and/or probability.

The method may comprise performing: functionality performed by an access network node.

The apparatus may be implemented by the access network node.

According to a thirteenth example, there is provided a method for an apparatus, the method comprising: signalling, to a policy control function, a request for quality of service for an application flow for which protocol data unit set based handling may apply, the request comprising a service identifier that indicates a plurality of media flows grouped together, and a coordination indication indicating that the grouping is for determining packet discard in the event of congestion has been detected in an access network and that a protocol data unit set importance value that identifies a priority of at least one protocol data unit set within a quality of service flow is to be used to identify a rate and/or probability at which the at least one protocol data unit set is to be discarded.

The method may comprise: signalling, to the policy control function, an offset value to be used in modifying the protocol data unit set importance value.

The method may comprise performing: functionality performed by at least one of: an application function or an application server.

The method may comprise performing: implementing a virtual network function instance of at least one of: an application function or an application server.

According to a fourteenth example, there is provided a method for an apparatus, the method comprising: receiving, from an application function, a request for quality of service for an application flow for which protocol data unit set based handling may be applied, the request comprising: a service identifier that indicates a plurality of media flows grouped together for the purpose of packet discard in the event of congestion has been detected in an access network; and a coordination indication indicating that a protocol data unit set importance value that identifies a priority of at least one protocol data unit set within a quality of service flow is to be used to identify a rate and/or probability at which the at least one protocol data unit set is to be discarded; generating at least one policy rule, the at least one policy rule comprising or being associated with a correlation identifier, and the coordination indication received; and providing the at least one policy rule to a session management function.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The method may comprise: receiving an offset value to be used in modifying the protocol data unit set importance value, wherein said generating further comprises comprising the offset value in the at least one policy rule.

The generating may be performed based on (e.g., using) at least one of: the service identifier, an application identifier, network slice, application identifier and/or a protocol description.

The method may comprise: generating the correlation identifier for associating a plurality of said at least one policy rules.

The method may comprise performing: functionality performed by a policy control function.

The method may comprise performing: implementing a virtual network function instance of a policy control function.

According to a fifteenth example, there is provided a method for an apparatus, the method comprising: receiving, from a policy control function, at least one policy rule, the at least one policy rule comprising or being associated with: a correlation identifier that indicates a plurality of media flows grouped together for the purpose of packet discard in the event of congestion has been detected in an access network; and a coordination indication that indicates that a protocol data unit set importance value that identifies a priority of at least one protocol data unit set within a quality of service flow is to be used to identify a rate and/or probability at which the at least one protocol data unit set is to be discarded; and providing the correlation identifier and the coordination indication to an access network node.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The method may comprise: determining at least one quality of service profile that associates at least one service data flow to a respective quality of service flow, said quality of service profile comprising the correlation identifier and the coordination identifier; and providing the at least one quality of service profile to an access network node.

The method may comprise: receiving, from the policy control function an offset value to be used in modifying the protocol data unit set importance value, wherein said determining the at least one quality of service profile comprises comprising the offset value in the at least one quality of service profile.

The method may comprise: functionality performed by a session management function.

The method may comprise: implementing a virtual network function instance of the session management function.

According to a sixteenth example, there is provided non-transitory computer readable medium comprising program instructions for causing an apparatus to perform: detecting congestion in an access network; identifying, for a quality of service flow, a rate and/or probability at which at least one protocol data unit set is to be discarded based on (e.g., using) an indication of a respective quality of service flow priority value and a respective protocol data unit set importance value that identifies a priority of the at least one protocol data unit set within the quality of service flow; and discarding the at least one protocol data unit set in accordance with the identified rate and/or probability.

A higher quality of service flow priority value may be associated with a higher rate and/or probability of discard when congestion is detected in the access network.

The protocol data unit set importance value may be received in a header from a user plane function.

The quality of service flow priority value may be received in a quality of service profile from a session management function.

The apparatus may be caused to perform: receiving, the respective quality of service flow priority value; and/or receiving, the respective protocol data unit set importance value.

The apparatus may be caused to perform: functionality performed by a user equipment.

The apparatus may be implemented by the user equipment.

The apparatus may be caused to perform: functionality performed by an access network node.

The apparatus may be implemented by the access network node.

The apparatus may be caused to perform: receiving, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify a rate and/or probability at which the at least one protocol data unit set is to be discarded in the multiple quality of service flows;
and using the correlation identifier to further identify said rate and/or probability at which the at least one protocol data unit set is to be discarded in the multiple quality of service flows.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may be caused to perform: receiving an offset associated with one or more Quality of Service Flows; and using the offset to modify the protocol data unit set importance value to create a modified protocol data unit set importance value that is used in identifying the rate and/or probability.

The Quality of Service Flows may be at least one of: Quality of Service flows for which a Quality of Service offset is received; and/or Quality of Service flows for which an offset is received and also have the same correlation identifier.

According to a seventeenth example, there is provided non-transitory computer readable medium comprising program instructions for causing an apparatus to perform: detecting congestion in an access network; identifying a rate and/or probability at which at least one protocol data unit set is to be discarded based on (e.g., using) a respective protocol data unit set importance value that identifies a priority of the at least one protocol data unit set within a quality of service flow, a correlation identifier that associates multiple quality of service flows, and an indication that the protocol data unit set importance value for the at least one protocol data unit set is to be used with the correlation identifier to identify the rate and/or probability at which the at least one protocol data unit set is to be discarded across multiple quality of service flows; and discarding the at least one protocol data unit set in the multiple quality of service flows in accordance with the identified rate and/or probability.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may be caused to perform: receiving an offset associated with one or more Quality of Service Flows; and using the offset to modify a protocol data unit set importance value to create a modified protocol data unit set importance value, wherein the modified protocol data unit set importance value is used in identifying the rate and/or probability at which the at least one protocol data unit set is to be discarded in the multiple quality of service flows

The apparatus may be caused to perform: receiving the respective protocol data unit set importance value; receiving the correlation identifier; and/or receiving the indication that the protocol data unit set importance value for the at least one protocol data unit set is to be used with the correlation identifier to identify a rate and/or probability at which the at least one protocol data unit set is to be discarded across multiple quality of service flows.

The apparatus may be caused to perform: receiving a quality of service profile, the quality of service profile comprising or being associated with at least one of: the correlation identifier, and/or the indication that the protocol data unit set importance value for the at least one protocol data unit set is to be used with the correlation identifier to identify a rate and/or probability at which the at least one protocol data unit set is to be discarded across multiple quality of service flows.

The apparatus may be caused to perform: receiving, for at least one quality of service flow, an indication of a respective quality of service flow priority value; and using the respective quality of service flow priority value to further identify said rate and/or probability.

The apparatus may be caused to perform: functionality performed by an access network node.

The apparatus may be implemented by the access network node.

According to an eighteenth example, there is provided non-transitory computer readable medium comprising program instructions for causing an apparatus to perform: signalling, to a policy control function, a request for quality of service for an application flow for which protocol data unit set based handling may apply, the request comprising a service identifier that indicates a plurality of media flows grouped together, and a coordination indication indicating that the grouping is for determining packet discard in the event of congestion has been detected in an access network and that a protocol data unit set importance value that identifies a priority of at least one protocol data unit set within a quality of service flow is to be used to identify a rate and/or probability at which the at least one protocol data unit set is to be discarded.

The apparatus may be caused to perform: signalling, to the policy control function, an offset value to be used in modifying the protocol data unit set importance value.

The apparatus may be caused to perform: functionality performed by at least one of: an application function or an application server.

The apparatus may be caused to perform: implementing a virtual network function instance of at least one of: an application function or an application server.

According to a nineteenth example, there is provided non-transitory computer readable medium comprising program instructions for causing an apparatus to perform: receiving, from an application function, a request for quality of service for an application flow for which protocol data unit set based handling may be applied, the request comprising: a service identifier that indicates a plurality of media flows grouped together for the purpose of packet discard in the event of congestion has been detected in an access network; and a coordination indication indicating that a protocol data unit set importance value that identifies a priority of at least one protocol data unit set within a quality of service flow is to be used to identify a rate and/or probability at which the at least one protocol data unit set is to be discarded; generating at least one policy rule, the at least one policy rule comprising or being associated with a correlation identifier, and the coordination indication received; and providing the at least one policy rule to a session management function.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may be caused to perform: receiving an offset value to be used in modifying the protocol data unit set importance value, wherein said generating further comprises comprising the offset value in the at least one policy rule.

The generating may be performed based on (e.g., using) at least one of: the service identifier, an application identifier, network slice, application identifier and/or a protocol description.

The apparatus may be caused to perform: generating the correlation identifier for associating a plurality of said at least one policy rules.

The apparatus may be caused to perform: functionality performed by a policy control function.

The apparatus may be caused to perform: implementing a virtual network function instance of a policy control function.

According to a twentieth example, there is provided non-transitory computer readable medium comprising program instructions for causing an apparatus to perform: receiving, from a policy control function, at least one policy rule, the at least one policy rule comprising or being associated with: a correlation identifier that indicates a plurality of media flows grouped together for the purpose of packet discard in the event of congestion has been detected in an access network; and a coordination indication that indicates that a protocol data unit set importance value that identifies a priority of at least one protocol data unit set within a quality of service flow is to be used to identify a rate and/or probability at which the at least one protocol data unit set is to be discarded; and providing the correlation identifier and the coordination indication to an access network node.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may be caused to perform: determining at least one quality of service profile that associates at least one service data flow to a respective quality of service flow, said quality of service profile comprising the correlation identifier and the coordination identifier; and providing the at least one quality of service profile to an access network node.

The apparatus may be caused to perform: receiving, from the policy control function an offset value to be used in modifying the protocol data unit set importance value, wherein said determining the at least one quality of service profile comprises comprising the offset value in the at least one quality of service profile.

The apparatus may be caused to perform: functionality performed by a session management function.

The apparatus may be caused to perform: implementing a virtual network function instance of the session management function.

According to a twenty first example, there is provided an apparatus comprising: detecting circuitry for detecting congestion in an access network; identifying circuitry for identifying, for a quality of service flow, a rate and/or probability at which at least one protocol data unit set is to be discarded based on (e.g., using) an indication of a respective quality of service flow priority value and a respective protocol data unit set importance value that identifies a priority of the at least one protocol data unit set within the quality of service flow; and discarding circuitry for discarding the at least one protocol data unit set in accordance with the identified rate and/or probability.

A higher quality of service flow priority value may be associated with a higher rate and/or probability of discard when congestion is detected in the access network.

The protocol data unit set importance value may be received in a header from a user plane function.

The quality of service flow priority value may be received in a quality of service profile from a session management function.

The apparatus may comprise: receiving circuitry for receiving, the respective quality of service flow priority value; and/or receiving circuitry for receiving, the respective protocol data unit set importance value.

The apparatus may comprise performing circuitry for performing: functionality performed by a user equipment.

The apparatus may be implemented by the user equipment.

The apparatus may comprise performing circuitry for performing: functionality performed by an access network node.

The apparatus may be implemented by the user equipment.

The apparatus may comprise: receiving circuitry for receiving, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify a rate and/or probability at which the at least one protocol data unit set is to be discarded in the multiple quality of service flows; and using circuitry for using the correlation identifier to further identify said rate and/or probability at which the at least one protocol data unit set is to be discarded in the multiple quality of service flows.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise: receiving circuitry for receiving an offset associated with one or more Quality of Service Flows; and using circuitry for using the offset to modify the protocol data unit set importance value to create a modified protocol data unit set importance value that is used in identifying the rate and/or probability.

The Quality of Service Flows may be at least one of: Quality of Service flows for which a Quality of Service offset is received; and/or Quality of Service flows for which an offset is received and also have the same correlation identifier.

According to a twenty second example, there is provided an apparatus comprising: detecting circuitry for detecting congestion in an access network; identifying circuitry for identifying a rate and/or probability at which at least one protocol data unit set is to be discarded based on (e.g., using) a respective protocol data unit set importance value that identifies a priority of the at least one protocol data unit set within a quality of service flow, a correlation identifier that associates multiple quality of service flows, and an indication that the protocol data unit set importance value for the at least one protocol data unit set is to be used with the correlation identifier to identify the rate and/or probability at which the at least one protocol data unit set is to be discarded across multiple quality of service flows; and discarding circuitry for discarding the at least one protocol data unit set in the multiple quality of service flows in accordance with the identified rate and/or probability.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise: receiving circuitry for receiving an offset associated with one or more Quality of Service Flows; and using circuitry for using the offset to modify a protocol data unit set importance value to create a modified protocol data unit set importance value, wherein the modified protocol data unit set importance value is used in identifying the rate and/or probability at which the at least one protocol data unit set is to be discarded in the multiple quality of service flows

The apparatus may comprise performing circuitry for performing: receiving the respective protocol data unit set importance value; receiving the correlation identifier; and/or receiving the indication that the protocol data unit set importance value for the at least one protocol data unit set is to be used with the correlation identifier to identify a rate and/or probability at which the at least one protocol data unit set is to be discarded across multiple quality of service flows.

The apparatus may comprise: receiving circuitry for receiving a quality of service profile, the quality of service profile comprising or being associated with at least one of: the correlation identifier, and/or the indication that the protocol data unit set importance value for the at least one protocol data unit set is to be used with the correlation identifier to identify a rate and/or probability at which the at least one protocol data unit set is to be discarded across multiple quality of service flows.

The apparatus may comprise: receiving circuitry for receiving, for at least one quality of service flow, an indication of a respective quality of service flow priority value;

and using circuitry for using the respective quality of service flow priority value to further identify said rate and/or probability.

The apparatus may comprise performing circuitry for performing: functionality performed by an access network node.

The apparatus may be implemented by the access network node.

According to a twenty third example, there is provided an apparatus comprising: signalling circuitry for signalling, to a policy control function, a request for quality of service for an application flow for which protocol data unit set based handling may apply, the request comprising a service identifier that indicates a plurality of media flows grouped together, and a coordination indication indicating that the grouping is for determining packet discard in the event of congestion has been detected in an access network and that a protocol data unit set importance value that identifies a priority of at least one protocol data unit set within a quality of service flow is to be used to identify a rate and/or probability at which the at least one protocol data unit set is to be discarded.

The apparatus may comprise signalling circuitry for signalling, to the policy control function, an offset value to be used in modifying the protocol data unit set importance value.

The apparatus may comprise performing circuitry for performing: functionality performed by at least one of: an application function or an application server.

The apparatus may comprise performing circuitry for performing: implementing a virtual network function instance of at least one of: an application function or an application server.

According to a twenty fourth example, there is provided an apparatus comprising: receiving circuitry for receiving, from an application function, a request for quality of service for an application flow for which protocol data unit set based handling may be applied, the request comprising: a service identifier that indicates a plurality of media flows grouped together for the purpose of packet discard in the event of congestion has been detected in an access network; and a coordination indication indicating that a protocol data unit set importance value that identifies a priority of at least one protocol data unit set within a quality of service flow is to be used to identify a rate and/or probability at which the at least one protocol data unit set is to be discarded; generating circuitry for generating at least one policy rule, the at least one policy rule comprising or being associated with a correlation identifier, and the coordination indication received; and providing circuitry for providing the at least one policy rule to a session management function.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise: receiving circuitry for receiving an offset value to be used in modifying the protocol data unit set importance value, wherein said generating further comprises comprising the offset value in the at least one policy rule.

The generating may be performed based on (e.g., using) at least one of: the service identifier, an application identifier, network slice, application identifier and/or a protocol description.

The apparatus may comprise: generating circuitry for generating the correlation identifier for associating a plurality of said at least one policy rules.

The apparatus may comprise performing circuitry for performing: functionality performed by a policy control function.

The apparatus may comprise performing circuitry for performing: implementing a virtual network function instance of a policy control function.

According to a twenty fifth example, there is provided an apparatus comprising: receiving circuitry for receiving, from a policy control function, at least one policy rule, the at least one policy rule comprising or being associated with: a correlation identifier that indicates a plurality of media flows grouped together for the purpose of packet discard in the event of congestion has been detected in an access network; and a coordination indication that indicates that a protocol data unit set importance value that identifies a priority of at least one protocol data unit set within a quality of service flow is to be used to identify a rate and/or probability at which the at least one protocol data unit set is to be discarded; and providing circuitry for providing the correlation identifier and the coordination indication to an access network node.

The correlation identifier and the indication that the protocol data unit set importance value for at least one protocol data unit set is to be used with the correlation identifier to identify the rate and/or probability at which the at least one protocol data unit set is to be discarded in the multiple quality of service flows may be combined in a single parameter.

The apparatus may comprise: determining circuitry for determining at least one quality of service profile that associates at least one service data flow to a respective quality of service flow, said quality of service profile comprising the correlation identifier and the coordination identifier; and providing circuitry for providing the at least one quality of service profile to an access network node.

The apparatus may comprise: receiving circuitry for receiving, from the policy control function an offset value to be used in modifying the protocol data unit set importance value, wherein said determining the at least one quality of service profile comprises comprising the offset value in the at least one quality of service profile.

The apparatus may comprise performing circuitry for performing: functionality performed by a session management function.

The apparatus may comprise performing circuitry for performing: implementing a virtual network function instance of the session management function.

According to a twenty sixth aspect, there is provided a computer program product stored on a medium that may cause an apparatus to perform any method as described herein.

According to a twenty seventh aspect, there is provided an electronic device that may comprise apparatus as described herein.

According to a twenty eighth aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows an example representation of a 5G system;

FIG. 2 shows an example representation of a network apparatus;

FIG. 3 shows an example representation of a user equipment;

FIG. 4 shows an example network architecture;

FIGS. 5 to 6 show example operations that may be performed; and

FIGS. 7 to 11 show example operations that may be performed.

### DETAILED DESCRIPTION

The following describes example operations that may be performed for more efficiently determining how to discard packets in a congested network.

In some examples, techniques are disclosed for enabling a transmitting entity to, when the transmitting entity determines itself to be transmitting over a congested link, determine how to prioritize packets for discard when there are a plurality of different

Quality of Service (QoS) streams to consider.

In more detail, in some network systems, QoS may be flow-based, in which packets are classified and marked with a respective QoS Flow Identifier (QFI).

The QoS flow is where policy and charging rules are enforced. Each QoS flow is characterized by a set of parameters that are defined in an associated and respective

QoS profile. The QoS flow provides an end-to-end forwarding treatment between a user equipment and a user plane function throughout the lifetime of a Protocol Data Unit (PDU) session.

A QoS Flow may be associated with a standardized QoS profile (which may be associated with a specific QFI), or with an operator-specific QoS profile (which may comprise attributes that are explicitly signalled between network elements as they are not preconfigured).

A Service Data Flow (SDF) comprises one or more flows of UE traffic that is classified by the type of service used, and one or more SDF can be transported in a same QoS flow when they share the same QoS treatment.

In the following, certain examples are explained with reference to devices that are often capable of communication via a wireless cellular system and mobile communication systems serving such mobile communication devices. For brevity and clarity, the following describes such examples with reference to a 5G wireless communication system. However, it is understood that such examples are not limited to 5G wireless communication systems, and may, for example, be applied to other wireless communication systems (e.g., current 6G proposals, IEEE 802.11, among others).

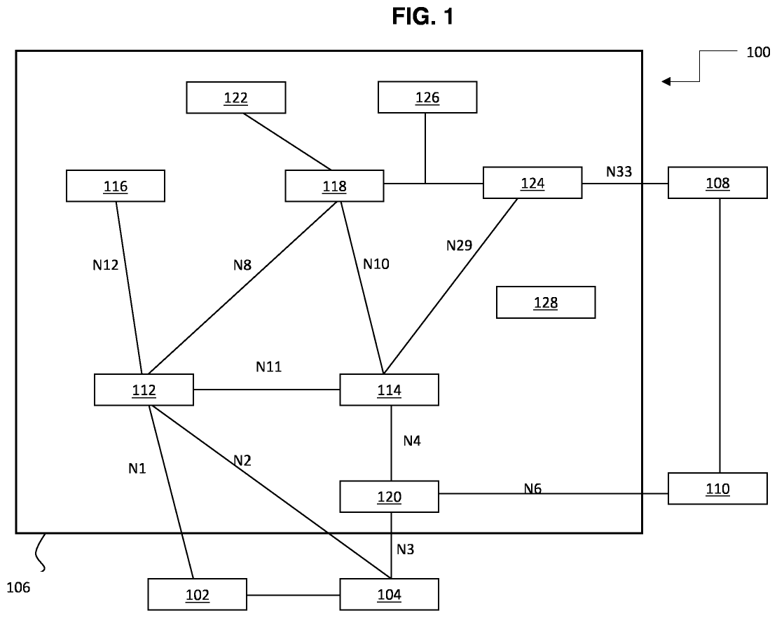

Before describing in detail the examples, certain facets of a 5G wireless communication system are briefly explained with reference to FIGS. 1 to 3.

FIG. 1 shows an example representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110. The UE may subscribe to receive at least one service from an AF. To help facilitate user traffic for the service to be delivered to the UE efficiently, the network may classify user traffic (e.g., Internet Protocol (IP) flows) into different service data flows (SDFs) having different Quality of Service (QoS) classes based on the type of service being provided through the SDFs. Different QoS rules may be applied to each SDF.

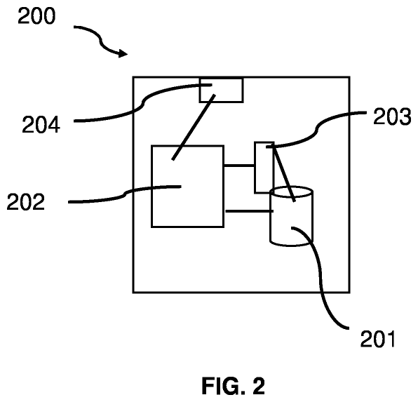

FIG. 2 shows an example of a control apparatus for a communication system, for example to be coupled to and/or for controlling a station of an access system, such as a RAN node, e.g. a base station, gNB, a central unit of a cloud architecture or a node of a core network such as an AMF or UPF, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

The station of the access system may be categorised into two different types: distributed units (DUs), and centralised units (CUs).

A DU provides access node support for lower layers of the protocol stack (e.g., the radio link control (RLC), medium access control (MAC), and/or physical layer protocol layers). Each DU is able to support one or more cells, while each cell is able to support one or more beams.

A CU can support multiple DUs, and provides access node support for higher layers of the protocol stack within an access node (e.g., packet data convergence protocol (PDCP), service data adaptation protocol (SDAP), and/or radio resource control (RRC) protocol layers). The interface between a CU and a DU is labelled as an F1 interface. There is a single CU for each gNB, and CU's belonging to multiple gNB may be implemented using a shared hardware platform.

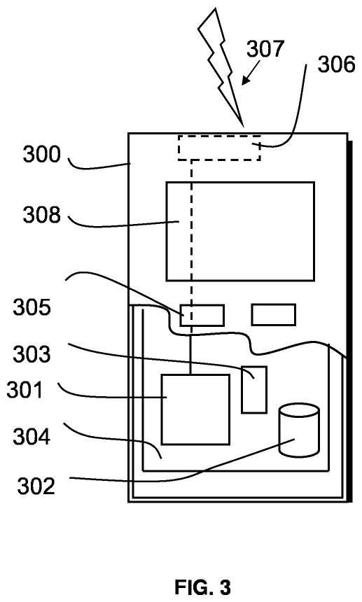

An example wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or a Virtual Reality device, Augmented Reality device, Mixed Reality device, or other Extended Reality such as a virtual reality headset, or any combinations of these or the like. A mobile communication device may provide, for example, communication of data for carrying communications such as voice, electronic mail (email), text message, multimedia and extended reality media and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may, for example, be a mobile device, that is, a device not fixed to a particular location, or it may be a stationary device. The wireless device may utilize human interaction for communication, or may not utilize human interaction for communication. As described herein, the terms UE, or “user” (more informally) can be used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be configured internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface, such as keypad 305, voice commands, touch sensitive screen or pad, combinations thereof or the like. A display or virtual reality headset/glasses 308, a speaker and a microphone can be also provided. Furthermore, a wireless communication device may comprise appropriate connectors (wired and/or’ wireless) to other devices and/or for connecting external accessories, for example hands-free equipment, thereto.

3GPP has issued a number of releases (Rel) for defining operating communication protocols related to a communications network. Currently, objectives and work are being set in relation to Release 18 (Rel. 18).

To support extended Reality (XR) and other real-time high bitrate applications in 3GPP networks, Release 18 has studied mechanisms for Integrated and Differentiated packet data unit (PDU) Set handling, as described in TS23.700-60. Integrated PDU Set handling processes all PDUs that belong to a PDU Set as a unit. For example, a PDU Set may be comprised of PDUs that carry a video frame (e.g. an I-Frame or a P-Frame). This processing may involve applying PDU Set parameters, such as a PDU Set Error Rate (PSER) and/or a PDU Set delay budget (PSDB), to the set of PDUs that comprise the PDU Set. Similarly Differentiated PDU Set handling may provide QoS handling that differentiates between PDU Sets, for example by applying different discard priority during congestion according to the Importance assigned to a PDU Set.

Work to standardize PDU Set handling is currently underway, and is being documented in 3GPP TS23.501, TS23.502 and TS23.503. A PDU Set comprises a group of one or more PDUs that carry the payload of one unit of information generated at the application level (e.g., a video frame or video slice for XR Services).

For downlink XR traffic, it has been agreed in 3GPP to support the detection of PDU Sets by a PDU Session Anchor (PSA) User Plane Function (UPF) and subsequent marking by the UPF of downlink GPRS (General Packet Radio Service) Tunnelling

Protocol-User plane (GTP-U) packets sent to an access network node (e.g., to an NG-RAN node). Integrated and differentiated PDU Set based QoS handling may be performed in the NG-RAN according to new Quality of Service (QoS) parameters that are applicable to the group of PDUs that form a PDU Set. These parameters may comprise a PDU Set Error Rate (PSER), a PDU Set Delay Budget (PSDB) and/or a PDU Set

Integrated Handling Indicator (PSIHI). The PSIHI indicates whether all PDUs in a PDU Set are needed by the application for it to process the application layer information at all. For differentiated QoS handling, it has been agreed to map PDU Sets from a same application service flow to a same QoS Flow, and to provide differentiated QoS handling based on (e.g., using) PDU Set Importance marking provided by the UPF (discussed further below).

An AF may send a request for PDU Set based QoS handling to a Network Exposure Function (NEF) and/or a Policy Control Function (PCF). The request may provide values for the PDU Set QoS parameters and Protocol Description information indicating the application protocol, header (e.g., Real Time Transport Protocol (RTP) and/or Secure Real Time Transport Protocol (SRTP)) and payload type (e.g. H.264) used by service data flow sent on the downlink to the UPF). This information may be in addition to Internet Protocol (IP) and transport (User Datagram Protocol (UDP) and/or Transmission Control Protocol (TCP)) layer service data flow identification information and QoS requirements, such as the maximum or guarantee bitrate sent by the AF. If the PCF authorizes the AF request, the PCF incorporates the AF information in a Policy and Charging Control (PCC) rule sent to the SMF.

Alternatively, PDU Set QoS parameters and Protocol Description may be more statically configured in the 5GS.

The SMF determines a QoS Flow for the XR traffic service data flow, sends new PDU Set QoS parameters to the RAN for the RAN to configure, and may send to the UPF, the Protocol Description information in the Packet Detection Rule (PDR) and/or an indication in the Forwarding Action Rule (FAR) that PDU Set information is to be sent to the RAN. The PSA UPF may use the Protocol Description information and implementation specific mechanisms (e.g., software and/or hardware) to detect the RTP and/or SRTP header and payload of downlink PDUs, determine PDU Sets, and/or extract PDU Set information. Alternatively, PSA UPF implementation specific procedures can be used for identifying PDU Sets even when the UPF does not receive specific Protocol Description Information (e.g., for proprietary application protocols other than RTP).

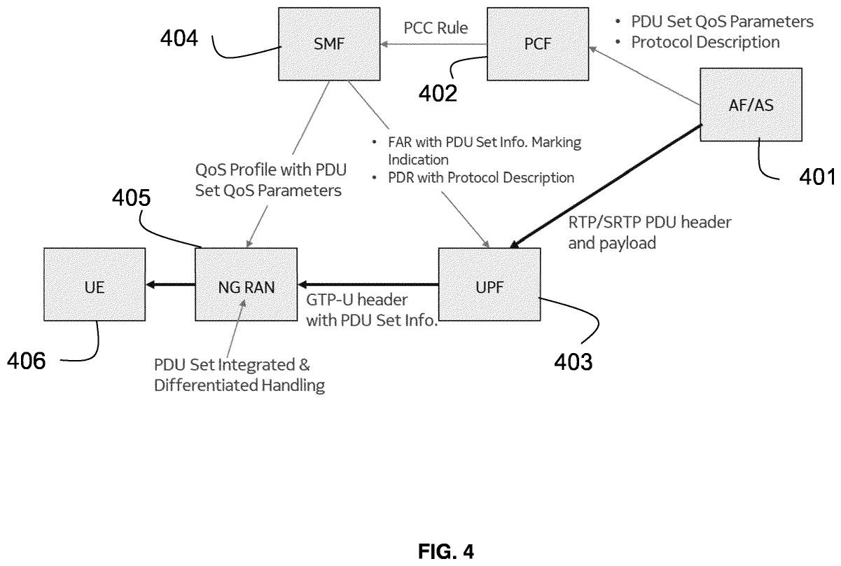

The overall process is depicted schematically in FIG. 4, which illustrates an example of PDU handling for applications, such as XR applications.

FIG. 4 illustrates an application function 401 configured to signal each of a PCF 402 and a UPF 403. The signalling from the application function 401 to the PCF 402 may comprise PDU set QoS parameters and/or a protocol description. The PCF may use the received information to create at least one PCC rule for a session, and provide this PCC rule to SMF 404. The SMF 404 may, in turn, provide the UPF 403 with FAR with PDU set information marking indication, and PDR with protocol description, and further provide a RAN network node 405 with a QoS profile comprising PDU set QoS parameters. The signalling from the application function 401 to the UPF may include a Protocol Description which describes Protocol information of the PDUs (e.g., which describes the protocol of data sent from the application function to the UE, such as the RTP and/or SRTP PDU header and payload type or any other PDU Protocol information). The UPF 402 may use this, information provided by the SMF, and UPF implementation specific mechanisms (e.g., hardware and/or software) to detect PDU sets and to indicate PDU Set information to the RAN network node 405 with data for a UE 406 using a GTP-U header comprising the PDU set information.

The PDU Set information, sent to the NG-RAN in the GTP-U header of user plane
PDUs, may comprise an indication of at least one of the following information:
PDU Set Sequence Number,
Indication of End PDU of the PDU Set,
PDU Sequence Number within a PDU Set,
PDU Set Size in bytes, or
PDU Set Importance, which identifies the importance of a PDU Set within a QoS Flow.

Of this signalling information, PDU Set Importance is the only GTP-U parameter provided by the UPF that differentiates PDU Sets according to the type of application/media layer payload/attributes represented. Stated differently, PDU Set Importance provides the only indication to an access network entity for how to prioritize between different PDU sets within a QoS flow. For example, a different importance value (e.g., PDU Set Importance value) can be given to a PDU carrying an Intra-coded-Frame (I-Frame) versus a Predicted-Frame (P-Frame) of a video stream, as the P-Frame is generally considered to be less important than an I-Frame for decoding data. The PDU

Set Importance value may therefore identify a relative importance of a PDU Set compared to other PDU Sets within a QoS Flow. The NG-RAN may use the PDU Set Importance for PDU Set level packet discarding in the presence of congestion.

PDU Sets may be detected and PDU set importance may thus be determined using UPF implementation specific mechanisms (e.g., hardware and/or software) based on (e.g., using) information provided in the user plane RTP/SRTP headers and payload.

However, when there are multiple QoS flows, whether for the same UE, same application, and/or different UEs and applications, handling of the discard priority is not clear.

For example, an application that sends multiple media components on different IP/UDP/RTP flows may want to favor one media type over another for the purposes of packet discard. For example, the application may be configured to prioritize audio and video over haptic (e.g., motion feedback) media when congestion occurs, such that haptic media is discarded before audio and video data is prioritized. In a more complicated example, the application may wish to favor a video data's base quality layer over audio data, while concurrently or simultaneously prioritizing audio data over video data's enhancement quality layers. Currently, there is no way for an application to indicate these types of preferences or the 5GS to enforce them.

As another example, the 5GS may be configured to prioritize (e.g., as a result of a configured policy at a 5GS entity) a selected media component, or a particular application instance (e.g. Streaming Company 1 vs. Streaming Company 2) over other media components and/or application instances when considering which packets to discard during congestion. Currently, there is no way for the 5GS to do this.

In one example, when a PDU Set based packet discard algorithm determines that during a congestion event, 10% of the PDU Sets with the lowest importance are to be discarded, there is no way for a radio access network node to determine that 5% of the PDUs are to be discarded from a higher priority video flow, and 15% are to be discarded from a lower priority favored video flow. Currently, an access network node would only consider PDU Set Importance within a QoS flow and discard would impact the two media streams equally.

In another example, a multi-modal application may have two video streams that are carried via two separate UEs. The application may have a preference regarding how the different layers or frame types of the two video streams should be prioritized for discard in the network. However, when they are carried across two separate QoS flows, it is not clear how to establish such preferences as the PDU Set importance parameter only applies within a single QoS flow.

The following aims to provide at least one mechanism for addressing at least one of the above-mentioned issues.

There are three example mechanisms that are described herein for helping to address at least one of these issues. Mechanisms 1 and 2 may be used independently while mechanism 3 may be used with either mechanism 1 or mechanism 2. The mechanisms may be implemented by, e.g., hardware and/or software.

In a first mechanism, the scope of the existing QoS Flow “Priority Level” (which is currently defined in 3GPP TS23.501 clause 5.7.3.3) is expanded, and/or a new QoS parameter is defined, to control discard of PDUs across QoS flows. The mechanism may be used either only for PDUs that belong to PDU Sets, or it may be applied regardless of whether or not PDUs belong to PDU Sets.

According to current definitions, the Priority Level associated with QoS characteristics indicates a priority in scheduling resources among QoS Flows. The lowest Priority Level value may, for example, correspond to the highest priority. A Priority Level may be configured in QoS profile

The Priority Level may be used to differentiate between QoS Flows of a same UE, and it may also be used to differentiate between QoS Flows from different UEs.

In the case of congestion, when all QoS requirements cannot be fulfilled for one or more QoS Flows, the Priority Level may be used to select for which QoS Flows the QoS requirements are prioritised, such that a QoS Flow with Priority Level value N is prioritized over QoS Flows with higher Priority Level values (i.e. N+1, N+2, etc). In the case of no congestion, the Priority Level may be used to define the resource distribution between QoS Flows. In addition, the scheduler may further prioritize QoS Flows based on (e.g., using) other parameters (e.g. resource type, radio condition, among others) in order to optimize application performance and network capacity.

For example, for PDUs in different QoS flows that belong to PDU Sets associated with a same PDU Set Importance value as each other, PDU Set discard can be applied in order, from lowest to highest QoS Flow Priority Level, or from lowest to highest value of the new QoS parameter. The Priority Level may be used to select a PDU Set Discard weight factor, where the weights distribute an overall discard probability (e.g., 10%) for a given PDU Set Importance unevenly across QoS Flows. This may allow, for example, a lower priority QoS flow to have a 15% discard probability, and a higher priority QoS Flow to have a 5% discard probability for a same given PDU Set Importance level.

The Priority Level may be used to differentiate between QoS Flows of the same UE. The Priority Level may alternatively or additionally be used to differentiate between

QoS Flows from different UEs. The Priority Level may be used by the RAN for determining downlink packet scheduling and how to discard downlink packets. The Priority Level may be used by the UE for determining uplink scheduling and determining how to discard uplink packets.

In a second mechanism, there is provided a new “importance-coordination” parameter. The importance-coordination parameter may be a quality of service parameter. The importance-coordination parameter may comprise a correlation identifier that is provided to an access network node and/or a UE across specific QoS flows.

The importance-coordination parameter may indicate to the access network node and/or the UE that the PDU Set importance value is comparable across QoS flows that are associated with the same correlation identifier and is to be used for packet discard decisions across QoS flows that are associated with the same correlation identifier. For instance, if, in the event of congestion, an access network node has PDU (Set) s with PDU Set importance values 1 and 3 waiting for delivery in one QoS flow, and PDU (Set) s with PDU Set importance values 2 and 4 from another QoS flow, it can discard them in a common order 4, 3, 2, 1 (from lowest PDU Set importance to highest PDU Set importance) across those QoS flows.

The importance-coordination parameter and a common correlation identifier may be set by the PCF in PCC rules related to service data flows. This means that the PCF can coordinate between service data flows in this way. The SMF may provide the parameter and the correlation identifier to the access network node and/or the UE for all corresponding QoS flows.

The PCF can make its determination regarding which importance-coordination value to attribute to each service data flow by the PCF's local configuration and various factors. The various factors may comprise, for example, whether the service data flows have a common Multi-Modal Service identifier indicating that they are associated with each other, a specific application identifier, and/or a specific “protocol description”. One specific protocol description relevant here is a new RTP header extension that will be defined by 3GPP SA4 (exactly what form and content has not been decided), which may comprise an “importance” header field whose value can be set directly by an application, and which can also be used directly by the UPF in its PDU Set importance assignment.

One approach to help PCF in its determination is to extend the Multi-Modal Service identifier with a new “importance-coordination” attribute, allowing the AF to request (e.g., explicitly) request for PDU Set importance value coordination across service data flows. For instance, if this is used together with the “protocol description” indicating the use of the RTP extension header comprising the importance header field, the new attribute with a common identifier could be used to indicate that the PDU Set importance value is indeed set in a coordinated manner across different service data flows.

As a third mechanism, a new QoS parameter indicating an offset between a PDU Set Importance marking in the QoS Flows can be provided by the AF and sent to the access network node, and/or the UE (e.g., via the PCF and SMF). The offset parameter may be used by the access network node and/or the UE to align PDU Set Importance marking levels between the QoS Flows to which cross-QoS flow PDU Set Importance discard is applied according to the first and/or second mechanism.

This offset parameter may be applicable when the AF provides (e.g., directly provides) PDU Set Importance markings as it may with an RTP Header extension being defined by 3GPP SA4 for enabling PDU Set processing in the 5GS.

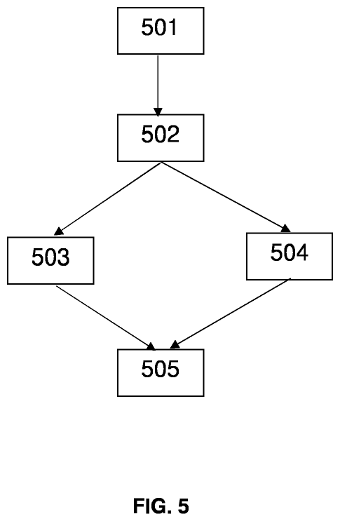

These mechanisms, which may be implemented by hardware and/or software, are illustrated with respect to FIGS. 5 to 11.

FIG. 5 illustrates one or more examples of how PDUs may be processed. These operations of FIG. 5 may comprise processing for any of uplink and downlink PDUs that have been assigned to PDU sets for discarding packets during congestion. In particular,

FIG. 5 illustrates PDU set discard across QoS flows according to PDU Set Importance and/or QoS Flow priority and/or QoS discard level parameters.

During 501, QoS Flow Priority level and/or QoS Discard Level parameters are assigned a value for QoS flows. These parameters may be provided to an access network node in a QoS profile. These parameters may be provided to a UE with QoS rules to apply for uplink transmission.

During 502, it is determined that congestion is occurring in the network. When the congestion is determined as being experienced in the downlink, the mechanism proceeds to 503. When the congestion is determined as being experienced in the uplink, the mechanism proceeds to 504.

During 503, for downlink PDUs, the access network node determines a PDU Set Discard Probability as a function of both a QoS Flow priority (or QoS Discard Level Parameter), and a PDU set importance information. The PDU Set importance information may, for instance, be received in headers of PDUs received from the UPF (e.g., GTP-U headers received from the UPF). From 503, the mechanism proceeds to 505.

During 504, for uplink PDUs, a UE determines the PDU Set discard Probability as a function of both the QoS Flow Priority (or QoS Discard Level Parameter), and the PDU Set importance information provided to or otherwise determined by the UE. From 504, the mechanism proceeds to 505. For example, in otherwise determining PDU Set Importance, the UE may detect protocol headers or use deep packet inspection to determine the importance of PDU Sets.

During 505, the network access node or UE (depending on whether 503 or 504 was performed) applies the PDU set discard according to the probabilities determined in their respective sets. Stated differently, the transmitting entity determines how to prioritize transmission packets for discard in order to reduce congestion in the network, with the prioritizing being performed based on (e.g., using) predetermined parameters.

Tables 1 and 2 illustrate examples how PDU Set importance-based packet discard may occur for at least two separate cases.

In particular, Table 1 illustrates an example of how PDU Sets may be prioritised for discard during congestion according to current systems, which only utilizes a value of the PDU Set Importance within a QoS Flow. In contrast, Table 2 illustrates an example of how PDU Sets may be prioritised for discard during congestion by considering both a QoS Flow Priority and/or a QoS Discard Level in addition to the PDU Set Importance value.

TABLE 1

| | PDU Set Discard |
|---|---|
| PDU Set | probability when |
| Importance | congestion = A |
| 1 | 1% |
| 2 | 4% |
| 3 | 8% |
| 4 | 10% |

Table 1 illustrates a probability of discard for different PDU set importance values according to prior systems. In this system of Table 1, all QoS flows have a same discard probability for a given PDU Set importance and congestion level.

TABLE 2

| QoS Flow Priority/QoS | | QoS Flow Priority/QoS | | QoS Flow Priority/QoS | |
|---|---|---|---|---|---|
| Discard Level: 1 | | Discard Level: 2 | | Discard Level: 3 | |
| | PDU Set | | PDU Set | | PDU Set |
| | Discard | | Discard | | Discard |
| | probability | | probability | | probability |
| | when | | when | | when |
| PDU Set | congestion = | PDU Set | congestion = | PDU Set | congestion = |
| Importance | A | Importance | A | Importance | A |
| 1 | 0.5% | 1 | 1% | 1 | 2% |
| 2 | 2% | 2 | 4% | 2 | 8% |
| 3 | 4% | 3 | 8% | 3 | 16% |
| 4 | 5% | 4 | 10% | 4 | 20% |

In contrast, Table 2 illustrates a probably of discard for different PDU set importance values for QoS flows having different QoS Discard Level and/or Quality of Service Flow Priority Level parameter value. In this example, QoS flows have different PDU Set Discard probabilities, in contrast to the example of Table 1.

In the cases illustrated in both of Tables 1 and 2, the percentage of PDU Sets discarded may be a function of the congestion level, with more PDU Sets at each PDU Set importance level being discarded when congestion is higher. In these examples, a higher PDU Set Importance value indicates lower importance and a higher QoS Flow Priority Level/QoS Discard Level indicates lower priority for the QoS Flow. This may be analogously thought of as PDU Sets associated with a higher QoS Flow Priority Level/QoS Discard Level being associated with a higher rate for discard than PDU Sets associated with a lower QoS Flow Priority Level/QoS Discard Level.

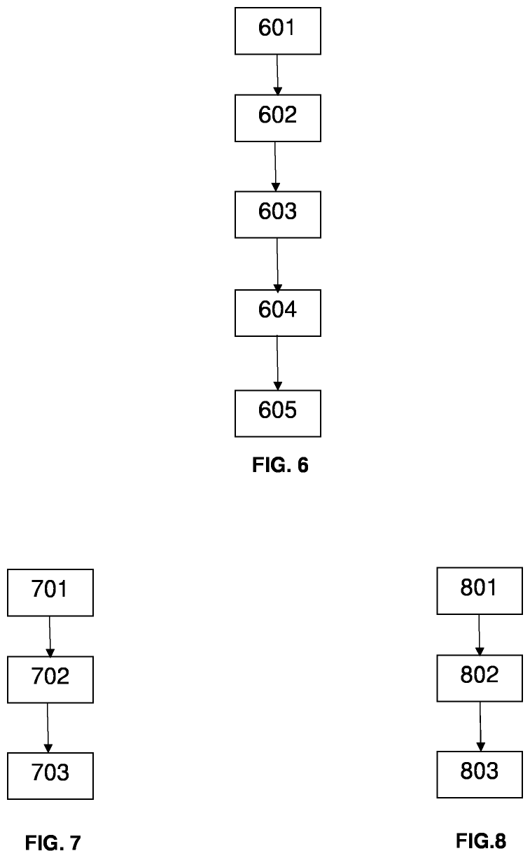

FIG. 6 provides an example of a mechanism that may be applied for PDU Set Discard across QoS Flows based on an application function request.

Therefore, FIG. 6 may be considered to illustrate at least the second and third mechanisms described above.

During 601, when sending requests for QoS for one or more application flows (e.g., application flow A) related to a UE, the AF may provide a multi-modal service identifier with an “importance-coordination” attribute associated to one or more of those application flows. Each application flow may carry one or more media flows, such as video, audio or haptic feedback streams (e.g., service data flow carrying media flow A). As mentioned above, the importance-coordination attribute may indicate that this application flow or media flows within this application flow may be considered together with any other application flows or media flows within one or more application flows with the same multi-modal service identifier value and the “importance-coordination” attribute for packet discard based on (e.g., using) a PDU Set Importance value. The AF may additionally send an “offset” for each service data flow. The offset may be used to align PDU Set Importance between service data flows. The AF may separately request QoS for any number of other application flows (e.g., application a flow B carrying media flow B) which may be related to the same or a different UE and use the same multi-modal service identifier value and the “importance-coordination” attribute to indicate they also belong under the same (PDU Set) importance value coordination “group”.

During 602, the PCF determines one or more PCC rules that comprise the new importance-coordination attribute and a respective correlation identifier that was provided to the PCF during 601. The PCC rule comprising this pair of values may also (where applicable) comprise the offset. The PCF may signal the determined PCC rule to an SMF to apply in respect of a session managed by the SMF for those media flows. The determination to comprise the importance-coordination attribute, correlation identifier, and (optionally) the offset, may be based on a request made in the AF request of 601 and/or other criteria (e.g., an application identifier, a protocol description, and so forth).

During 603, the PCC rules determined during 602 are received at the SMF. The SMF then maps service data flows and the Media Flows they carry to different QoS Flows (e.g., Media Flow A to QoS Flow-1, and Media Flow B to QoS Flow-2). For each QoS Flow, a correlation identifier and importance-coordination attribute (and potentially Offset, if available) may be added to the QoS Profile of that QoS Flow. The QoS Profile is subsequently sent to an access network node.

During 604, for QoS flows for which an importance-coordination attribute is received from the SMF and that are associated with an Offset, the access network node may adjust any PDU Set Importance values received in a header (e.g., a GTP-U header) of received packets by the associated Offset.

During 605, the access network node performs PDU Set discard across QoS Flows having a same (e.g., common) correlation identifier as each other when congestion is detected (e.g., based on the detected congestion). The PDU Set discard may be based on (e.g., using) the PDU Set Importance value as is or PDU Set Importance adjusted by the Offset. The PDU Set discard may be based on (e.g., using) a QoS Flow Priority Level and/or QoS Discard Level, as discussed above in relation to FIG. 5 and Tables 1 and 2.

Therefore, in FIG. 6, a PCF identifies media components where a PDU Set Importance can be considered across Media Flows that may be mapped to different QoS Flows. The identification by the PCF may be performed based on information provided by an AF. The PCF determines an importance-coordination attribute, which may activate PDU Set Importance-based packet discard across the QoS flows that are associated with a same correlation identifier. The correlation identifier, importance-coordination attribute and optional Offset information may be passed to an access network node. The access network node may apply an inter-QoS Flow PDU Set discard to QoS Flows that are associated with a common correlation identifier and for which the importance-coordination is activated.

An example of how the operations of FIG. 6 may be implemented are described below with reference to a first UPF, UPF1, and a second UPF, UPF2.

UPF-1 marks PDUs in QoS Flow 1 with PDU Set Importance values=1, 2, 3, 4

UPF-2 marks PDUs in QoS Flow 2 with PDU Set Importance values=3, 4, 5, 6

When an Offset for QoS Flow 2 is set to 2 and an Offset of QoS Flow 1 is set to zero, QoS Flow 2 PDU Set Importance values are adjusted from 3,4,5,6 to 1,2,3,4 before being compared to the PDU Set Importance values in QoS Flow 1.

Using different example Offsets, when Offset for QoS Flow 2 is set to −1 and an Offset of QoS Flow 1 is set to zero, QoS Flow 2 PDU Set Importance values are adjusted to 4,5,6,7 before being compared to the PDU Set Importance values in QoS flow 1.

Elements of the above example may find correspondence in features mentioned below with respect to FIGS. 7 to 11. It is therefore understood that FIGS. 4 to 6 may be used to illustrate functionally of the below when implemented in various examples.

FIG. 7 illustrates features that may be performed by an apparatus. The apparatus may comprise functionality of a user equipment. The apparatus may comprise functionality of an access network node (e.g., a radio access network node, such as a gNB).

During 701, the apparatus detects congestion in an access network.

During 702, the apparatus identifies, for a quality of service flow, a rate and/or probability at which at least one protocol data unit set is to be discarded based on (e.g., using) an indication of a respective quality of service flow priority value and a respective protocol data unit set importance value that identifies a priority of the at least one protocol data unit set within the quality of service flow. The identifying may be performed in response to the congestion being detected. The identifying may be performed based on the detected congestion.

During 703, the apparatus discards the at least one protocol data unit set in accordance with the identified rate and/or probability.

A higher quality of service flow priority value may be associated with a higher rate and/or probability of discard when congestion is detected in the access network.

The protocol data unit set importance value may be received in a header from a user plane function.

The quality of service flow priority value may be received in a quality of service profile from a session management function.

The apparatus may receive the respective quality of service flow priority value; and/or receive, the respective protocol data unit set importance value. For example, the apparatus may receive this information from a user plane function. It is understood that the apparatus may independently determine the respective quality of service flow priority value, and/or independently determine the respective protocol data unit set importance value. These independent determinations may comprise identifying at least one of the respective quality of service flow priority value and/or the respective protocol data unit set importance value using information preconfigured at the apparatus. These independent determinations may comprise deriving (e.g., calculating using at least one value input into a calculation function) at least one of the respective quality of service flow priority value and/or the respective protocol data unit set importance value using information preconfigured at the apparatus and/or received from another apparatus.

The apparatus may receive an offset associated with one or more Quality of Service Flows. The apparatus may use the offset to modify the protocol data unit set importance value to create a modified protocol data unit set importance value, wherein the modified protocol data unit set importance value is used in identifying the rate and/or probability.

When the apparatus is an access network node, the apparatus may receive, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify a rate and/or probability at which the at least one protocol data unit set is to be discarded in the multiple quality of service flows.

The apparatus may use the correlation identifier to further identify said rate and/or probability at which the at least one protocol data unit set is to be discarded in the multiple quality of service flows.

When the apparatus is an access network node, the apparatus may receive an offset associated with one or more Quality of Service Flows. The apparatus may use the offset to modify the protocol data unit set importance value to create a modified protocol data unit set importance value, wherein the modified protocol data unit set importance value is used in identifying the rate and/or probability to be discarded in the multiple quality of service flows.

In all of the above, the Quality of Service Flows may be at least one of: Quality of Service flows for which a Quality of Service offset is received; and/or Quality of Service flows for which an offset is received and also have the same correlation identifier.

FIG. 8 illustrates operations that may be performed by an apparatus, The apparatus may comprise functionality of an access network node.

During 801, the apparatus detects congestion in an access network.

During 802, the apparatus identifies a rate and/or probability at which at least one protocol data unit set is to be discarded based on (e.g., using) a respective protocol data unit set importance value that identifies a priority of the at least one protocol data unit set within a quality of service flow, a correlation identifier that associates multiple quality of service flows, and an indication that the protocol data unit set importance value for the at least one protocol data unit set is to be used with the correlation identifier to identify a rate and/or probability at which the at least one protocol data unit set is to be discarded across multiple quality of service flows. The identifying may be performed in response to the congestion being detected. The identifying may be performed based on the detected congestion.

During 803, the apparatus discards the at least one protocol data unit set in the multiple quality of service flows in accordance with the identified rate and/or probability

The apparatus may receive an offset associated with one or more Quality of Service Flows. The offset may be received in a quality of service profile.

The apparatus may use the offset to modify a protocol data unit set importance value to create a modified protocol data unit set importance value, wherein the modified protocol data unit set importance value is used in identifying the rate and/or probability at which the at least one protocol data unit set is to be discarded in the multiple quality of service flows.

The apparatus may receive the respective protocol data unit set importance value (e.g., from a UPF and/or SMF). The apparatus may receive the correlation identifier (e.g., from a UPF and/or SMF). The apparatus may receive (e.g., from a UPF and/or SMF) the indication that the protocol data unit set importance value for the at least one protocol data unit set is to be used with the correlation identifier to identify a rate and/or probability at which the at least one protocol data unit set is to be discarded across multiple quality of service flows.

The apparatus may receive the respective quality of service flow priority value; and/or receive, the respective protocol data unit set importance value. For example, the apparatus may receive this information from a user plane function. It is understood that the apparatus may independently determine the respective quality of service flow priority value, and/or independently determine the respective protocol data unit set importance value. These independent determinations may comprise identifying at least one of the respective quality of service flow priority value and/or the respective protocol data unit set importance value based on (e.g., using) information preconfigured at the apparatus. These independent determinations may comprise deriving (e.g., calculating using at least one value input into a calculation function) at least one of the respective quality of service flow priority value and/or the respective protocol data unit set importance value using information preconfigured at the apparatus and/or received from another apparatus.

The apparatus may receiving a quality of service profile, the quality of service profile comprising or being associated with at least one of: the correlation identifier, and/or the indication that the protocol data unit set importance value for the at least one protocol data unit set is to be used with the correlation identifier to identify a rate and/or probability at which the at least one protocol data unit set is to be discarded across multiple quality of service flows.

The apparatus may receive, for at least one quality of service flow, an indication of a respective quality of service flow priority value. The apparatus may use the respective quality of service flow priority value to further identify said rate and/or probability.

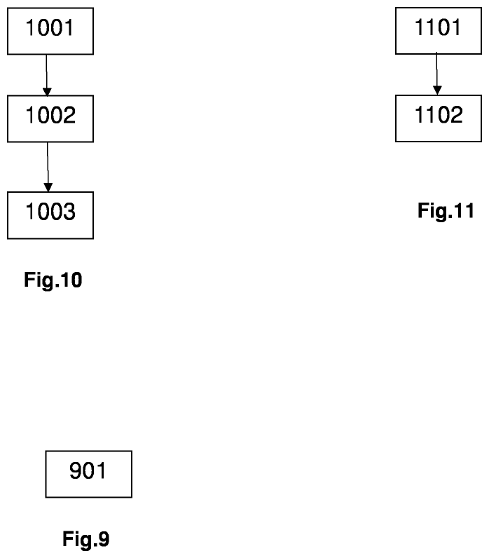

FIG. 9 illustrates operations that may be performed by an apparatus. The apparatus may comprise the functionality for performing as an application function and/or application server.

During 901, the apparatus signals, to a policy control function, a request for quality of service for an application flow for which protocol data unit set based handling may apply, the request comprising a service identifier that indicates a plurality of media flows grouped together, and a coordination indication indicating that the grouping is for determining packet discard in the event of congestion has been detected in an access network and that a protocol data unit set importance value that identifies a priority of at least one protocol data unit set within a quality of service flow is to be used to identify a rate and/or probability at which the at least one protocol data unit set is to be discarded.

The apparatus may signal, to the policy control function, an offset value to be used in modifying the protocol data unit set importance value.

FIG. 10 illustrates operations that may be performed by an apparatus. The apparatus may comprise the functionality for performing functions of a policy control function.

During 1001, the apparatus receives, from an application function, a request for a quality of service for an application flow for which protocol data unit set based handling may be applied, the request comprising: a service identifier that indicates a plurality of media flows grouped together for the purpose of packet discard in the event of congestion has been detected in an access network; and a coordination indication indicating that a protocol data unit set importance value that identifies a priority of at least one protocol data unit set within a quality of service flow is to be used to identify a rate and/or probability at which the at least one protocol data unit set is to be discarded.

During 1002, the apparatus generates at least one policy rule, the at least one policy rule comprising or being associated with a correlation identifier, and the coordination indication received.

During 1003, the apparatus provides the at least one policy rule to a session management function.

The apparatus may receive an offset value to be used in modifying the protocol data unit set importance value, wherein said generating further comprises comprising the offset value in the at least one policy rule. The apparatus may receive the offset value from the application function and/or application server.

The generating may be performed based on (e.g., using) at least one of: the service identifier, an application identifier, network slice, application identifier and/or a protocol description.

The apparatus may generate the correlation identifier for associating a plurality of said at least one policy rules.

FIG. 11 illustrates operations that may be performed by an apparatus. The apparatus may comprise the functionality for performing functions of a session management function.

During 1102, the apparatus may receive, from a policy control function, at least one policy rule, the at least one policy rule comprising or being associated with: a correlation identifier that indicates a plurality of media flows grouped together for the purpose of packet discard in the event of congestion has been detected in an access network; and a coordination indication that indicates that a protocol data unit set importance value that identifies a priority of at least one protocol data unit set within a quality of service flow is to be used to identify a rate and/or probability at which the at least one protocol data unit set is to be discarded.

During 1102, the apparatus may provide the correlation identifier and the coordination indication to an access network node.

The apparatus may determine at least one quality of service profile that associates at least one service data flow to a respective quality of service flow, said quality of service profile comprising the correlation identifier and the coordination identifier. The apparatus may provide the at least one quality of service profile to an access network node. This may be provided by signalling the quality of service profile to the access network node. This may be provided by signalling an index value indicating the quality of service profile to the access network node.

The apparatus may receive, from the policy control function an offset value to be used in modifying the protocol data unit set importance value, wherein said determining the at least one quality of service profile comprises comprising the offset value in the at least one quality of service profile.

In all of the above examples, the correlation identifier and the indication that the protocol data unit set importance value for at least one protocol data unit set is to be used with the correlation identifier to identify a rate and/or probability at which the at least one protocol data unit set is to be discarded in the multiple quality of service flows may be combined in a single parameter (e.g., the two parameters may be represented by a single parameter).

In all of the above examples, the correlation identifier and the indication that the protocol data unit set importance value for at least one protocol data unit set is to be used with the correlation identifier to identify a rate and/or probability at which the at least one protocol data unit set is to be discarded in the multiple quality of service flows may be combined in respective parameters (e.g., the two parameters may be represented by respective parameters).

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the examples described herein.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) Internet Protocol multimedia subsystems (IMS) and expected 6G systems or any combination thereof.

As provided herein, various examples are described in the detailed description. In general, some examples may be implemented in hardware or special purpose circuits, software code, logic or any combination thereof. For example, some examples may be implemented in hardware, while other examples may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 7, and/or FIG. 8, and/or FIG. 9, and/or FIG. 10, and/or FIG. 11, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used herein, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the examples described herein. Indeed, there is a further implementation comprising a combination of one or more examples with any of the other examples described herein.

The following passages pertain to an example of how one or more changes may be reflected in 3GPP, with the underlined portions corresponding to particular examples of the above. The numbering of these sections may correspond to Sections comprised in 3GPP TS23.501.

### 5.7.3.3 Priority Level

The Priority Level associated with 5G QoS characteristics indicates a priority in scheduling resources among QoS Flows. The lowest Priority Level value corresponds to the highest priority.

The Priority Level may be used to differentiate between QoS Flows of the same UE, and it shall also be used to differentiate between QoS Flows from different UEs.

In the case of congestion, when all QoS requirements cannot be fulfilled for one or more QoS Flows, the Priority Level may be used to select for which QoS Flows the QoS requirements are prioritised such that a QoS Flow with Priority Level value N is prioritized over QoS Flows with higher Priority Level values (i.e. N+1, N+2, etc). In the case of congestion, when PDU Set based QoS handling is active for a QoS flow, Priority Level shall be used with PDU Set Importance to affect PDU Set prioritization across QoS Flows, In the case of no congestion, the Priority Level should be used to define the resource distribution between QoS Flows. In addition, the scheduler may prioritize QoS Flows based on other parameters (e.g. resource type, radio condition) in order to optimize application performance and network capacity.

Every standardized 5QI is associated with a default value for the Priority Level-specified in QoS characteristics Table 5.7.4.1). Priority Level may also be signalled together with a standardized 5QI to the -R) AN, and if it is received, it shall be used instead of the default value.

Priority Level may also be signalled together with a pre-configured 5QI to the (R) AN, and if it is received, it shall be used instead of the pre-configured value.

### 5.37.5.2 PDU Set Information and Identification

To support PDU Set based QoS handling, the PSA UPF identifies PDUs that belong to PDU Sets and determines the below PDU Set Information which it sends to the NG-RAN in the GTP-U header. The PDU Set information is used by the NG-RAN for PDU Set based QoS handling as described above.

The PDU Set Information comprises:
PDU Set Sequence Number.
Indication of End PDU of the PDU Set.
PDU Sequence Number within a PDU Set.
PDU Set Size in bytes.
PDU Set Importance, which identifies the relative importance of a PDU Set compared to other PDU Sets within a QoS Flow.

The NG-RAN may use Priority Level across QoS Flows (see clause 5.7.3.3) and the PDU Set Importance within a QoS Flow for PDU Set level packet discarding in presence of congestion.

Editor's note: The PDU Set Size is pending SA WG4 progress on SA WG4 5G_RTP WI. It is up to SA4 to decide whether PDU Set Size in an SA4 defined RTP header, extension header and/or payload is in bytes and whether the PDU Set Size in an SA WG4 defined RTP header, extension header and/or payload includes the RTP and/or IP overhead.

NOTE: The PDU Set Information can be different for different PDU Sets within a QoS Flow.

The SMF instructs PSA UPF to perform PDU Set marking and may provide the PSA UPF the Protocol Description indicating the header, extension header (e.g. RTP/SRTP) and payload type (e.g. H.264) used by the service data flow. The Protocol Description may be received in the PCC rule, based on information provided by the AF or by PCF local policies as described in clause 5.37.5.1.

PSA UPF can identify the PDU Set information using the Protocol Description and the received RTP/SRTP headers or using implementation specific means (e.g., implementation specific mechanism).

Editor's note: PDU Set Information in RTP/SRTP header, extension header and/or payload is pending SA WG4 progress on SA WG4 5G_RTP WI.

For each DL PDU received on N6 for which PDU Set based QoS handling is indicated from the SMF, the PSA UPF applies the rules for PDU Set identification and provides PDU Set Information which is available to the RAN in the GTP-U header.

1. An apparatus comprising:
at least one processor; and
at least one memory storing instructions that, when executed by the at least one processor, cause the apparatus at least to perform:
detecting congestion in an access network;
determining, for a quality of service flow, how at least one protocol data unit set is to be discarded based on an indication of a respective quality of service flow priority value and a respective protocol data unit set importance value that identifies a priority of the at least one protocol data unit set within the quality of service flow; and
discarding, based on said detection, the at least one protocol data unit set in accordance with said determining.

2. The apparatus as claimed in claim 1,
wherein a higher quality of service flow priority value is associated with a higher rate and/or probability of discard when congestion is detected in the access network.

3. The apparatus as claimed in claim 1,
wherein the protocol data unit set importance value is received in a header from a user plane function.

4. The apparatus as claimed in claim 1,
wherein the quality of service flow priority value is received in a quality of service profile from a session management function.

5. The apparatus as claimed in claim 1,
wherein the at least one memory stores the instructions that, when executed by the at least one processor, further cause the apparatus at least to perform:
receiving, the respective quality of service flow priority value; and/or
receiving, the respective protocol data unit set importance value.

6. The apparatus as claimed in claim 1,
wherein the at least one memory stores the instructions that, when executed by the at least one processor, further cause the apparatus at least to perform
functionality performed by a user equipment.

7. The apparatus as claimed in claim 6,
wherein the apparatus is implemented by the user equipment.

8. The apparatus as claimed in claim 1,
wherein the at least one memory stores the instructions that, when executed by the at least one processor, further cause the apparatus at least to perform
functionality performed by an access network node.

9. The apparatus as claimed in claim 8,
wherein the apparatus is implemented by the access network node.

10. The apparatus as claimed in claim 8,
wherein the at least one memory stores the instructions that, when executed by the at least one processor, further cause the apparatus at least to perform:
receiving, from a session management function, one or more quality of service profiles, the quality of service profiles comprising a correlation identifier that associates multiple quality of service flows and an indication that the protocol data unit set importance value for at least one protocol data unit set is to be used with the correlation identifier to identify the rate and/or probability at which the at least one protocol data unit set is to be discarded in the multiple quality of service flows; and
using the correlation identifier to further identify said rate and/or probability at which the at least one protocol data unit set is to be discarded in the multiple quality of service flows.

11. The apparatus as claimed in claim 10,
wherein the correlation identifier and the indication that the protocol data unit set importance value for at least one protocol data unit set is to be used with the correlation identifier to identify the rate and/or probability at which the at least one protocol data unit set is to be discarded in the multiple quality of service flows are combined in a single parameter.

12. The apparatus as claimed in claim 1,
wherein the at least one memory stores the instructions that, when executed by the at least one processor, further cause the apparatus at least to perform:
receiving an offset associated with one or more Quality of Service Flows; and
using the offset to modify the protocol data unit set importance value to create a modified protocol data unit set importance value that is used in identifying the rate and/or probability.

13. The apparatus as claimed in claim 12,
wherein the Quality of Service Flows are at least one of: Quality of Service flows for which a Quality of Service offset is received; and/or Quality of Service flows for which an offset is received and also have the same correlation identifier.

14. A method for an apparatus, the method comprising:
detecting congestion in an access network;
determining, for a quality of service flow, how at least one protocol data unit set is to be discarded based on an indication of a respective quality of service flow priority value and a respective protocol data unit set importance value that identifies a priority of the at least one protocol data unit set within the quality of service flow; and
discarding, based on said detecting, the at least one protocol data unit set in accordance with said determining.

15. A computer program comprising instructions which, when executed by an apparatus, cause the apparatus to perform:
detecting congestion in an access network;
determining, for a quality of service flow, how at least one protocol data unit set is to be discarded based on an indication of a respective quality of service flow priority value and a respective protocol data unit set importance value that identifies a priority of the at least one protocol data unit set within the quality of service flow; and
discarding, based on said detecting, the at least one protocol data unit set in accordance with said determining.
